(19) United States
(12) Patent Application Publication
(10) Pub. No.: US 2023/0408251 A1
(43) Pub. Date: Dec. 21, 2023

(54) Multimodal Proximity and Visuotactile Sensing Through Transmissive Membrane

(71) Applicant: The Trustees of the University of Pennsylvania, Philadelphia, PA (US)

(72) Inventors: James Henry Pikul, Philadelphia, PA (US); Mark Yim, St. Davids, PA (US); Jessica Yin, Philadelphia, PA (US)

(21) Appl. No.: 18/327,981

(22) Filed: Jun. 2, 2023

Related U.S. Application Data
(60) Provisional application No. 63/350,934, filed on Jun. 10, 2022.

(51) Int. Cl. G01B 11/24; H04N 23/11; H04N 23/13

(52) U.S. Cl. CPC G01B 11/24; H04N 23/11; H04N 23/13

(57) ABSTRACT

A visuotactile sensor, comprising: a deformable membrane; and an imaging train, the deformable membrane allowing at least partial transmission of light therethrough and onto the imaging train such that the imaging train collects light reflected through the membrane by an object on the opposite side of the membrane or contacting the membrane, and the imaging train further configured to collect light indicative of a deformation of the membrane by the object. A method, comprising: with an imaging train, collecting (a) a first light reflected through a deformable membrane by an object proximate to or contacting the deformable membrane and (b) a second light indicative of a deformation of the deformable membrane; and relating the at least one of the first light and the second light to an estimated position of the object, an estimated motion of the object, and an estimated deformation experienced by the membrane.

### CROSS-REFERENCE TO RELATED APPLICATIONS

The present application claims priority to and the benefit of U.S. patent application No. 63/350,934, “Multimodal Proximity And Visuotactile Sensing Through Transmissive Membrane” (filed Jun. 10, 2022). All foregoing applications are incorporated herein by reference in their entireties for any and all purposes.

### GOVERNMENT RIGHTS

This invention was made with government support under 1935294 awarded by the National Science Foundation. The government has certain rights in the invention.

### TECHNICAL FIELD

The present disclosure relates to the field of visual sensor systems.

### BACKGROUND

The most common sensing modalities found in a robot perception system are vision and touch, which together can provide global and highly localized data for manipulation. However, these sensing modalities often fail to adequately capture the behavior of target objects during the critical moments as they transition out of static, controlled contact with an end-effector to dynamic and uncontrolled motion. Accordingly, there is a long-felt need in the art for improved sensors.

### SUMMARY

In meeting the described long-felt needs, the present disclosure provides In this work, we present a novel multimodal visuotactile sensor that provides simultaneous visuotactile and proximity depth data. The sensor integrates an RGB camera and air pressure sensor to sense touch with an infrared time-of-flight (ToF) camera to sense proximity by leveraging a selectively transmissive soft membrane to enable the dual sensing modalities. We present the mechanical design, fabrication techniques, algorithm implementations, and evaluation of the sensor's tactile and proximity modalities. The sensor is demonstrated in three open-loop robotic tasks: approaching and contacting an object, catching, and throwing. The fusion of tactile and proximity data could be used to capture key information about a target object's transition behavior for sensor-based control in dynamic manipulation.

Provided is a visuotactile sensor, comprising: a deformable membrane; and an imaging train, the deformable membrane allowing at least partial transmission of light therethrough and onto the imaging train such that the imaging train collects light reflected through the membrane by an object on the opposite side of the membrane or contacting the membrane, and the imaging train further configured to collect light indicative of a deformation of the membrane by the object.

Also provided is a system, comprising: a visuotactile sensor that comprises a deformable membrane and an imaging train, the imaging train configured to collect (i) light reflected through the deformable membrane by an object proximate to or contacting the membrane and (ii) light indicative of a deformation of the deformable membrane; and a mechanism, the system configured to actuate the mechanism in response to a light collected by the imaging train, the light being indicative of any one or more of a position of the object, a motion of the object, and a deformation experienced by the membrane.

Further provided is a method, comprising: with an imaging train, collecting (a) a first light reflected through a deformable membrane by an object proximate to or contacting the deformable membrane and (b) a second light indicative of a deformation of the deformable membrane; and relating the at least one of the first light and the second light to an estimated position of the object, an estimated motion of the object, and an estimated deformation experienced by the membrane.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1C. FIG. 1A. Proximity depth map from internal depth camera.

FIG. 1B. Image from internal RGB camera for tactile data. FIG. 1C. External view of object contacting membrane.

FIGS. 2A-2D. FIG. 2A. Soft membrane in ambient room light. FIG. 2B. Soft membrane with UV-phosphorescent dot grid pattern activated by 365 nm UV light. FIG. 2C. Overview of sensor system. FIG. 2D. Sensor mounted on UR10 robot arm.

FIGS. 3A-3C. FIG. 3A. Depth map before dot correction algorithm is applied. FIG. 3B. Dots detected by blob detector in the depth and RGB images. FIG. 3C. Depth map after dot correction is applied.

FIGS. 4A-4D. Top row: test object, middle row: corresponding proximity depth map, bottom row: corresponding tactile RGB image. FIG. 4A. Solderless breadboard. FIG. 4B. Shark torpedo. FIG. 4C. Nail polish. FIG. 4D. Rubik's cube.

FIG. 5. Measured distance compared to ground truth distance for a flat plane over a range of 10-100 mm.

FIGS. 6A-6B. Proximity depth and tactile sensing data: FIG. 6A. Before the sensor makes contact with the nail polish. FIG. 6B. After the sensor makes contact with the nail polish.

FIGS. 7A-7B. Proximity depth and tactile sensing data: FIG. 7A. Before the Rubik's cube makes contact with the sensor. FIG. 7B. After the Rubik's cube makes contact.

FIGS. 8A-8B. Proximity depth and tactile sensing data, with the target object circled in yellow: FIG. 8A. Prior to throwing the hex head cap. FIG. 8B. After throwing the hex head cap.

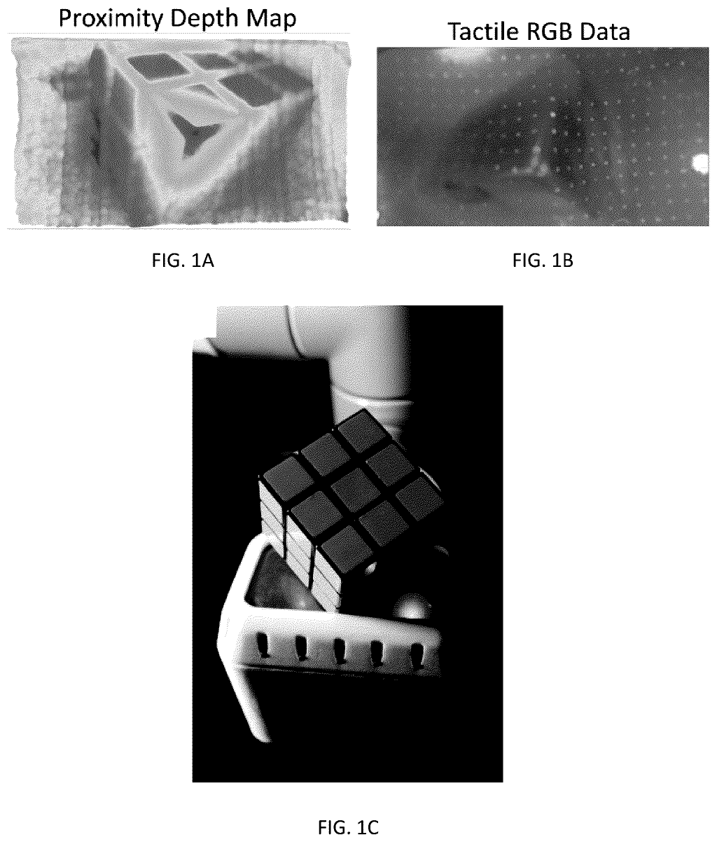

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

Approaches to perception for robot manipulation have largely mimicked the human form, focusing on the development and integration of vision sensors far from the target object and compliant tactile sensors embedded in the end effector. However, robots still struggle to achieve dexterous and dynamic manipulation capabilities comparable to humans. This can be largely attributed to large uncertainties stemming from an imperfect perception of the target object [1]. The accuracy of the object's pose estimation can make the difference between success and failure, which can be seen in “basic” tasks such as grasping, but is further amplified in dexterous and dynamic tasks that lack simple contact models and quasi-static assumptions to inform the interaction [2].

While vision sensors provide rich data about the environment and can be used to localize the target object within it, the localization estimate is not very precise—typically within a few centimeters around the object. Additionally, vision sensors are frequently occluded by robot arms as they reach towards the target or by clutter in the environment. An obvious short-term solution may be to simply add more cameras, but complete coverage of the target and workspace is not guaranteed even with multiple cameras and is not practical for real-world environments.

Tactile sensors on robot fingers and palms have been explored as a potential solution to provide more precise data about the object during contact, such as location and forces [3]. These sensors are usually designed to have mechanical compliance for increased robustness to unexpected contacts and greater functionality with the irregular or delicate geometries found in everyday objects. However, tactile sensors are only useful once the object is already in contact with the end effector, which may not be sufficient for tasks that require bringing the object in and out of contact, such as dynamic reorientation.

This points to a fundamental gap in a perception pipeline that only uses vision and touch. Closing this perception gap is necessary to create a robust perception pipeline that will allow robots to tackle more difficult manipulation tasks. A potential solution to address this gap is adding a proximity sensing modality, which can be defined as sensing within a short distance range originating from the locations of the tactile sensors [4]. Proximity sensing can provide the precise localization data that vision sensors lack and information about pre- and post-contact behavior that is difficult to predict due to complex frictional dynamics.

In this application, we illustrate the disclosed technology via an illustrative, non-limiting embodiment that includes a novel multimodal proximity and visuotactile sensor that provides simultaneous tactile and proximity depth data. The sensor is able to detect contact over an inflated 96 mm by 54 mm elastomer membrane with an RGB camera (960×540) and air pressure sensor, while providing depth data with an infrared (IR) ToF camera (640×480) at a synchronous sampling rate of 30 Hz. An infrared-transmissive and visibly translucent elastomer membrane, embedded with UV-phosphorescent particles, enables the simultaneous reading of visible tactile data on the membrane and IR proximity data. We introduce a sensor fusion algorithm that uses both the RGB image and depth image to correct for the effect of the embedded particles in the depth image, and evaluate the depth data up to 100 mm from the sensing surface. The sensor is integrated into an end-effector and mounted on a UR10 (Universal Robots) robot arm and demonstrated with the following open-loop tasks: approach and contact, catching, and throwing.

The development of compliant tactile sensors has grown dramatically, producing a diverse set of tactile sensing approaches. Soft tactile sensors can be broadly divided into two categories: embedded sensor arrays in a soft electronic skin and visuotactile sensors. The embedded sensor arrays use transduction mechanisms such as capacitance and piezoresistive changes to sense deformation. However, high resolution and large coverage versions of these sensors typically suffer from complex wiring requirements and intricate fabrication processes that hinder integration into robotic applications [5]. Visuotactile sensors are a common tactile sensing strategy in robotics due to their high resolution, large coverage, and relatively easy fabrication process.

Visuotactile sensors contain a camera that observes a visual pattern on the internal surface of a soft membrane for tactile data [6]. The soft membrane deforms when an object makes contact with it and the visual pattern distorts. This distortion of the visual pattern will be captured by the camera and can then be used to estimate tactile data, such as object geometry, shear displacement, torque, force, and contact area. Yuan et. al. [7] popularized this strategy with GelSight, which uses a dot pattern on the surface of the membrane to track deformation and frustrated total internal reflection to estimate depth and provide high resolution data about a target object. Numerous sensors such as GelSlim [8], DIGIT [9], and Omnitact [10] have demonstrated this strategy in different form factors. However, the visuotactile sensing mechanism based on frustrated total internal reflection fundamentally prohibits the integration of a proximity modality, and these sensors can struggle to resolve ambiguous tactile imprints to determine an object's pose.

Alspach et. al. [11] introduced the Soft Bubble/Punyo tactile sensor which embeds a ToF depth camera in an air filled chamber with a compliant membrane. The depth data from the ToF camera is used to sense deformations of the membrane's surface, but does not see through the surface. There are a wide range of proximity sensing strategies, from optical fibers [12] to single time-of-flight sensor point measurements [13]. Proximity sensing has mostly been implemented on the fingertips of robotic grippers for pre-grasp object detection [14] and improved grasping [15]. However, these proximity sensors are limited in spatial resolution, which prevents many tasks, such as object recognition and tracking.

Yamaguchi et. al. introduced FingerVision [16], which uses stereo vision to observe a clear elastomer surface marked with black dots and was shown to improve dexterous tasks such as vegetable cutting. This design, however, requires a compromise between tactile and proximity resolutions as adding more tactile dots would require occluding the proximity vision. Hogan et. al. [17] proposed See-Through-Your-Skin, a large countertop sensing surface that achieves modulated transparency via the two-way mirror effect for visual and tactile data. Although this device provides both proximity and tactile data, it cannot provide both simultaneously and has a limited deformation range due to its rigid platform. Multimodal proximity and tactile sensing has also been achieved through magnetic [18] and capacitive sensing [19], although the functionality of the proximity sensing depends on compatibility with the target object's capacitive properties or placement of magnetic stickers around the workspace and on the object. We build upon previous work in multimodal proximity and visuotactile sensing and extend it with high spatial resolution depth data and synchronized, real-time tactile and proximity data. Furthermore, our tactile and proximity modalities cause minimal to no interference with the other, leading to uncompromised spatial resolution of each modality.

The following is a non-limiting illustration of the disclosed technology.

Design and Fabrication

Selectively Transmissive Soft Membrane

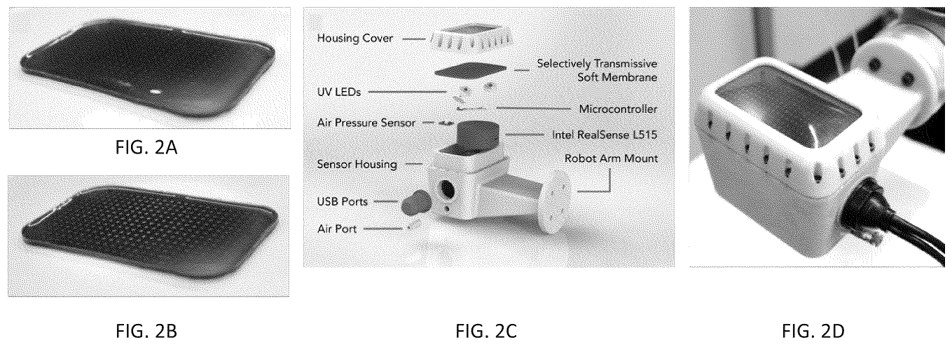

The soft membrane is designed to be selectively transmissive to achieve the following: (1) allow the infrared light (860 nm) emitted by the time-of-flight camera to pass through, (2) block most of the visible light (400 nm-700 nm) from the external environment, and (3) enable the activation of the phosphorescent, light-emitting particles (500 nm) on the inner surface from internal UV LEDs (365 nm). Blocking external visible light enhances the visual contrast with the green-colored phosphorescent particles (FIG. 2A, 2B), facilitating the facile application of off-the-shelf OpenCV algorithms for tracking [20]. Additionally, the membrane is designed to be physically resilient for repeated use in contact-rich interactions, while providing a highly compliant contact surface. The thickness of the membrane can be decreased for greater infrared light transmissivity, but at the cost of reduced physical robustness and opacity to external light.

The membrane is fabricated in layers, by letting each silicone elastomer layer fully cure prior to pouring the next layer. The base silicone elastomer (Ecoflex 00-30; Smooth-On) has an attenuation of 10 db/cm at 860 nm and therefore transmits most of the emitted infrared light from the depth camera. The first layer consists of Ecoflex 00-30 mixed by hand with a dye solution (Epolight 7276B; Epolin, dissolved in chloroform, concentration) in a 15:1 (mL) elastomer to dye solution ratio. The dye is formulated to be visibly opaque and infrared transmissive. We pour 8.25 g of the dyed elastomer into an Ease-Release-coated laser cut mold and place it in a vacuum degassing chamber for 10 minutes. Then, the mold is placed on a hot plate and heat-cured at 100° C. for 10 minutes.

The next layer consists of the UV-phosphorescent particles in a dot grid pattern. The UV-phosphorescent particles are made of Cu:ZnS (copper doped zinc sulfide, 35 microns; Technoglow). We mixed 0.2 g of Cu:ZnS with 2 g of Ecoflex 00-30 by hand. We laser cut a 0.508 mm stencil made of clear PVC to the shape of the membrane and desired dot grid pattern (1 mm diameter, 4 mm uniform spacing, 328 total dots). The first layer of the membrane is then removed from the mold and placed onto a glass plate. We press the stencil onto the membrane to remove air bubbles and the Cu:ZnS elastomer mixture is spread onto the surface with a cotton Q-tip. The stencil is removed after about 15 seconds and the glass plate with the membrane cures on a hot plate at 100° C. for 10 minutes.

The final layer evens out the protrusions from the dot grid layer and leaves a slightly matte finish to reduce specular reflections from the infrared and UV lights. We mix Ecoflex 00-30 with NOVOCS Matte silicone solvent (Smooth-On) in a 3:6 (g) solvent to elastomer ratio and degas for 10 minutes. Finally, we pour 4 g of the mixture onto the membrane and cure at 100° C. on a hot plate for 10 minutes.

Internal Electronics

We chose to use the Intel Realsense L515 because it provides integrated RGB and ToF depth cameras, as well as the ability to adjust the ToF laser power to bring the minimum sensing range to approximately 50 mm for short range sensing. The field of view (FOV) of the RGB camera is 70° by 43° and the FOV of the depth camera is 70° by 55°. Because the FOVs don't exactly align, the active sensing area in this work only consists of the overlapping regions of both FOVs. The cameras output data through the same USB-C port, which is connected to an airtight USB-A 3.0 port that goes through the sensor housing.

The internal air pressure sensor can sense absolute air pressures from OPSI-25 PSI The air pressure sensor is connected to a microcontroller and samples the air pressure at 30 Hz. We inflate the membrane to a gauge pressure of 0.02 PSI to reduce the specular reflection of the internal UV and IR lights.

We soldered three UV LEDs (365 nm, surface mount; Uxcell) onto aluminum heat sinks (Chanzon) and connected them in series with 50 mΩ resistance. The LED circuit is connected to the direct USB power output pin on the microcontroller, which provides 2.1A. The microcontroller is connected to the USB-A port that goes through the sensor housing. An overview of the internal components of the sensor system is shown in FIG. 2C.

Sensor Housing

The 3D printed (DraftGray, Objet 30 Prime; Stratasys) sensor housing consists of the main sensor chamber and the cover. Threaded inserts are glued with epoxy resin (Gorilla 2 part epoxy; Gorilla Glue) around the housing and the cover is attached with M3 screws. The lid and the screws clamp the membrane down and create an airtight seal. The main sensor housing also has ports for the push-to-connect tube fitting and the dual USB-A 3.0 port. The sensor housing includes a mounting plate for the UR10 arm (FIG. 2D).

Sensor Characterization

Dot Correction Through Sensor Fusion

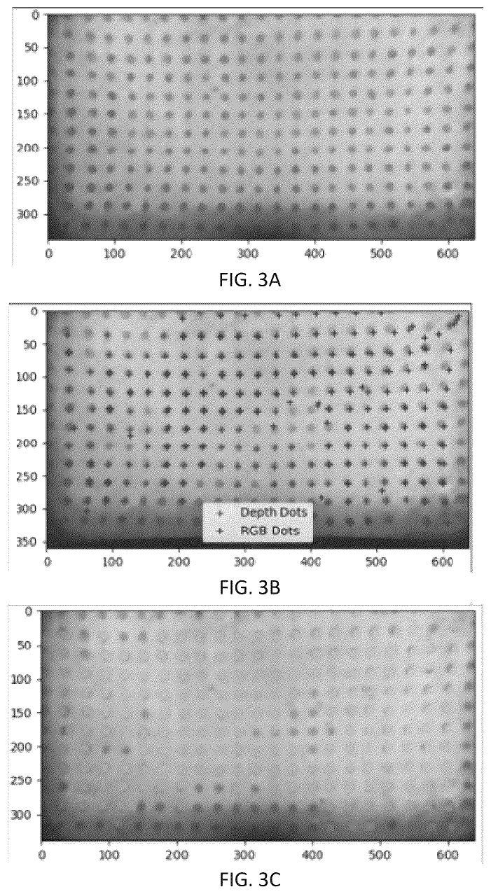

While the membrane is designed to maximize transmission of the emitted infrared light for depth sensing, the UV phosphorescent dots do introduce some light scattering compared to an unpatterned region of the membrane. The dots are imperceptible in the depth map when an object is within approximately 40 mm of the sensing surface and when it is in contact. This is potentially because the object is reflecting enough infrared light back such that scattering effects become negligible. However, a distinct dot pattern appears in the depth map when sensing objects far away from the sensor (greater than 40 mm), with the dot-patterned regions appearing 2 mm-4 mm closer to the camera. We correct for the dot pattern in the depth map by fusing the depth and RGB data (FIGS. 3A-3C). Because the dots are always visible and actively tracked with the RGB camera, the RGB images can be used to apply corrections when the dots are affecting the depth images.

To map the dots in the RGB data to their correct location within the depth map, we first align the RGB frame to the depth frame. The RGB and ToF cameras are located less than 2 cm apart and approximately within the same plane. We estimated the relevant transform matrix from calibration data to align the RGB and depth images. The transform matrix was then manually tuned based on the overlap of the transformed RGB image and depth data from a flat plane resting 100 mm from the sensors. This tuned transform was found to be appropriate for all image alignments with object distances between 40 mm and 100 mm from the sensor.

After the visual image is aligned to the depth frame, we used the simple blob detector from OpenCV to identify and locate the dots in both the depth image and the aligned RGB image. Dots are assumed to exist in the superset of these two sets of detected dots. At each dot location, localized smoothing is applied based on the distance values of the neighboring points. We take the distance value from eight pixels (one from each cardinal and ordinal direction) and apply the average of these eight distances to a grid centered at the center of the dot. Finally, a global smoothing is applied with a Gaussian blur.

Proximity Depth Sensing

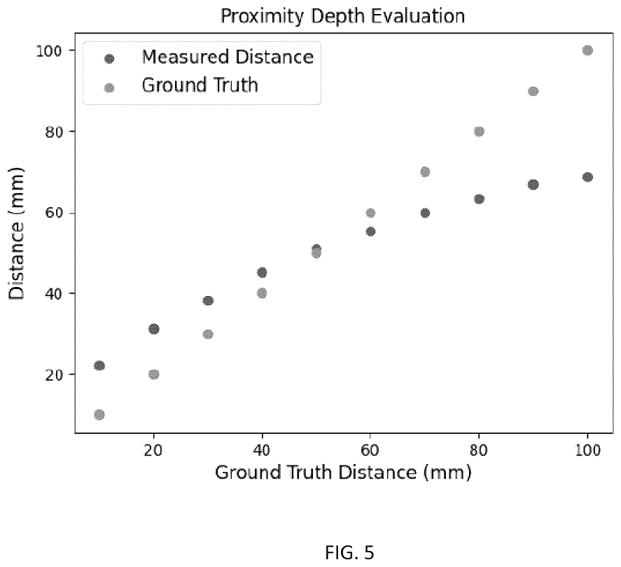

In this section, we characterize the proximity depth sensing. The relevant settings for the Intel Realsense L515 are the following: laser power—10, receiver gain—18, digital gain—1, minimum distance—0 mm, and all filters (confidence, decimation, noise) and pre-/post-processing sharpening turned off. These settings are kept consistent throughout this work. A test stand with discrete slots from 10 mm-100 mm in 10 mm increments mounts a flat plane parallel to the sensing surface. Four sheets of white printer paper (92 brightness) cover the flat plane and encompass the entire FOV of the depth sensing. We apply the dot correction algorithm and average 20 consecutive frames for evaluation of the data. The average depth pixel value of the depth data has an R²=0.725 fit with the ground truth distance (FIG. 5).

The lowest average error, 1 m m, occurs at a distance of 50 mm, while the largest average error, 31 mm, occurs at a distance of 100 mm. The sensor tends to both underestimate further distances and overestimate closer distances because the returned signals are generally weaker than its out-of-the-box calibration. The depth data shows spatially varying accuracy at further distances, particularly above the 50 mm distance range, due to the convex nature of the laser power output [22].

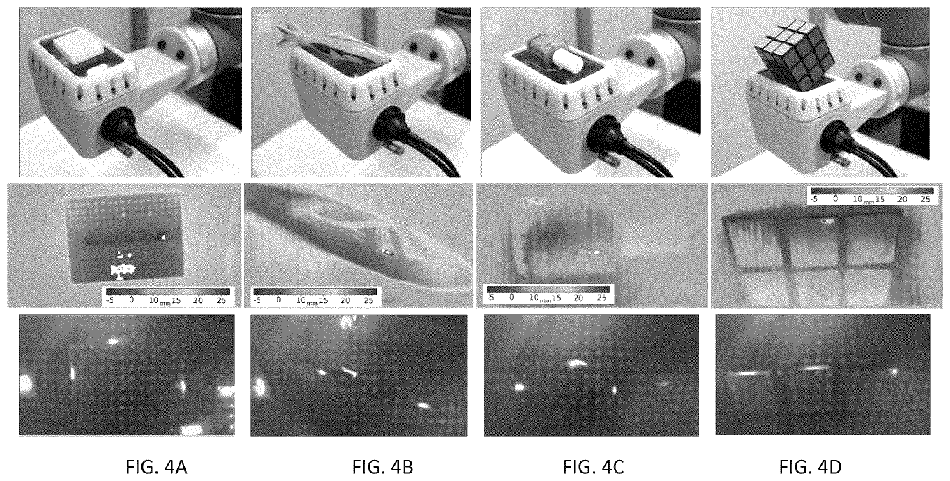

FIGS. 4A-4D show depth maps of objects placed on the surface of the sensor. We compared the depth maps to the significant dimensions of each object and found an average overall error of 4.3%. The sensor showed poorer performance on curved surfaces, with the average error of 5.5% and much better on edges, with an average error of 2%.

Perhaps due to the on-chip confidence algorithm, an object in contact with the sensor causes the entire surface of the membrane to be sensed. This feature of the sensor should be tested with a more extensive range of objects, but it has remained consistent with the object dataset tested thus far. The reflectance properties of the object's surface has a significant effect on the quality of the depth map. For example, the black lines of the Rubik's cube overemphazies the separation of each square because it absorbs more of the infrared light, which is interpreted as further away from the sensor. On the other hand, the white center divider strongly reflects infrared light and thus shows up as much closer to the sensor than the rest of the breadboard. Additionally, object geometries such as edges can lead to deformations in the membrane such that the UV and/or infrared light is specularly reflected and cause outliers in the data, such as on the lower half of the breadboard in FIG. 4A.

Tactile Sensing

Tactile sensing is achieved by measuring the change in the internal air pressure and by tracking the motion of the dots on the internal membrane surface. The dots are detected in the RGB image with the simple blob detector and tracked with the Lucas-Kanade optical flow algorithms from OpenCV. The simple blob detector finds the center coordinates of each dot in each frame, and then the optical flow calculates the distance between its initial position and current position. To detect contact, the total flow velocity summed from all the dots act as a proxy for the magnitude of membrane deformation, and therefore total contact force. An RGB image of an uncontacted and inflated membrane initializes the optical flow and subsequent frames are compared to the uncontacted state. The air pressure sensor uses gauge pressure for contact detection.

Measuring both the internal air pressure and flow velocity for binary contact detection extends the range of contact that can be detected. The internal air pressure is more sensitive to contact and can detect forces below 100 g, which are not sufficient to create an appreciable change in flow velocity. The flow velocity is particularly useful for detecting tangential forces and lateral motions of the object along the sensing surface, which may not produce significant changes in the air pressure. The sensitivity of the flow velocity contact detection can be tuned to detect different ranges of forces by changing the window size of the optical flow algorithm.

Demonstrations

We mounted the sensor to a UR10 robot arm and demonstrated tasks where it could be beneficial to use both proximity and tactile sensing modalities. Although the tasks are open-loop, they provide a first step towards sensor-based control.

Approach and Contact

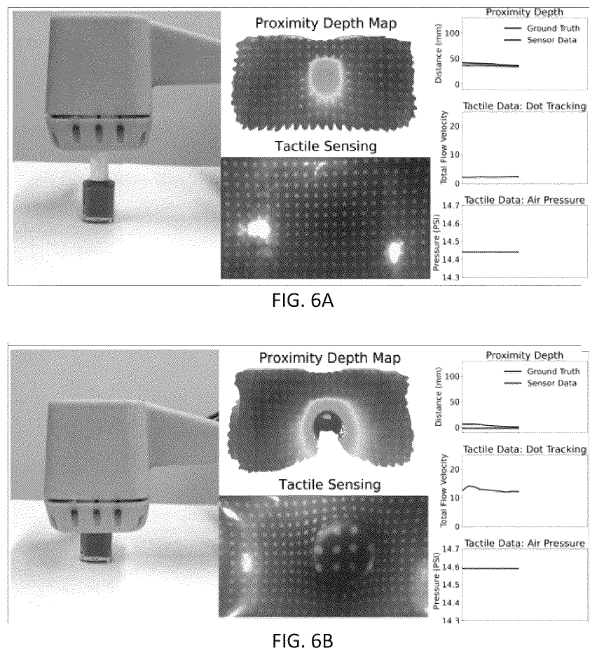

The robot performs an approach and contact task with a bottle of nail polish placed on a table. The sensor's initial position faces the nail polish 80 mm above the object (FIG. 6A). The robot arm then moves the sensor towards the bottle at 50 mm/s until it makes contact and protrudes 10 mm into the sensing surface (FIG. 6B). After waiting for 1 s, the robot arm moves the sensor up and away from the object. The pose of the end effector from the robot arm, sampled at 30 Hz, provides the ground truth for the distance accuracy of the sensor. The proximity and tactile sensing data shows good agreement of when contact occurred. The proximity depth data did not sense the object well beyond 40 mm, although once the object was within 40 mm of the sensor, it showed a good agreement with ground truth.

Catching

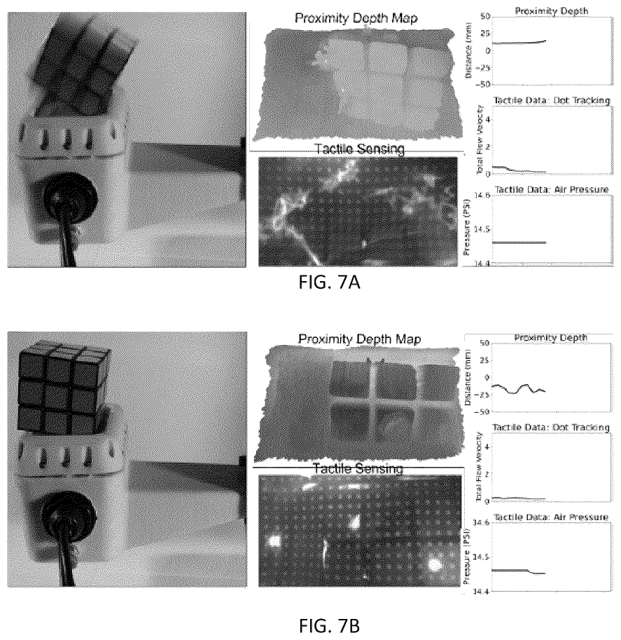

To demonstrate catching, the arm-mounted sensor faces the ceiling and a Rubik's cube is dropped onto the sensor from a height of 80 mm (FIGS. 7A-7B). The Rubik's cube slightly bounces off the rigid edge of the sensor before settling onto the membrane. The proximity depth data senses the Rubik's cube 13 frames before it makes contact with the membrane. Both the proximity depth data and tactile sensing data match well qualitatively with a video recording of the experiment.

Throwing

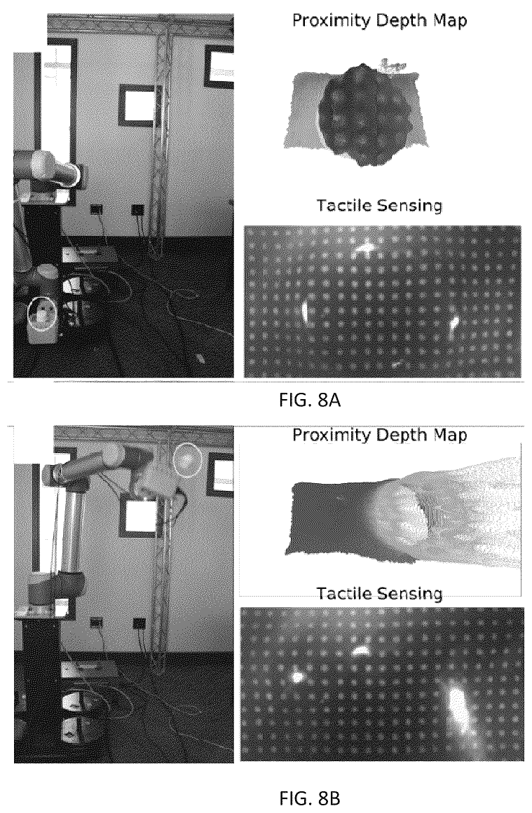

In this demonstration, the UR10 arm throws a 46 mm diameter PVC hex head cap off the surface of the sensor (FIGS. 8A-8B). The final speed of the end effector is approximately 1.5 m/s. Until the hex head cap is thrown, it remains in contact with the sensor, although we observe some lateral rocking during the wind-up trajectory in both the tactile and proximity data. The tactile and proximity data both show loss of contact at the end of the throw. After the hex head cap is thrown, the sensor captures 6 frames of the hex head cap's initial projectile motion.

### SUMMARY

In this study, we introduced a novel multimodal proximity depth and visuotactile sensor enabled by a selectively transmissive elastomer membrane. We presented the design and fabrication techniques for each component of the sensor, and we evaluated the proximity depth data across a distance range of 10 mm-100 mm. Both the binary contact detection and proximity depth modalities were tested with an object dataset consisting of nail polish, Rubik's cube, breadboard, shark torpedo, and PVC hex head cap. We integrated the sensor into an end-effector to mount on a UR10 robot arm and demonstrated it in three open-loop tasks where the mixed modality of the sensor could provide an advantage. The demonstrations and quality of the data show potential for the application of this sensor to capture target object behavior before, during, and after contact in dynamic and dexterous manipulation tasks.

### REFERENCES

[1] Aude Billard and Danica Kragic. “Trends and challenges in robot manipulation”. In: Science 364.6446 (2019).
[2] Fabio Ruggiero, Vincenzo Lippiello, and Bruno Siciliano. “Nonprehensile dynamic manipulation: A survey”. In: IEEE Robotics and Automation Letters 3.3 (2018), pp. 1711-1718.
[3] Qiang Li, Oliver Kroemer, Zhe Su, et al. “A review of tactile information: Perception and action through touch”. In: IEEE Transactions on Robotics 36.6 (2020), pp. 1619-1634.
[4] Stefan Escaida Navarro, Stephan Mu″hlbacher-Karrer, Hosam Alagi, et al. “Proximity Perception in Human-centered Robotics: A Survey on Sensing Systems and Applications”. In: IEEE Transactions on Robotics (2021).
[5] Cheng Chi, Xuguang Sun, Ning Xue, et al. “Recent progress in technologies for tactile sensors”. In: Sensors 18.4 (2018), p. 948.
[6] Kazuhiro Shimonomura. “Tactile image sensors employing camera: A review”. In: Sensors 19.18 (2019), p. 3933.
[7] Wenzhen Yuan, Siyuan Dong, and Edward H Adelson. “Gelsight: High-resolution robot tactile sensors for estimating geometry and force”. In: Sensors 17.12 (2017), p. 2762.
[8] Elliott Donlon, Siyuan Dong, Melody Liu, et al. “Gelslim: A high-resolution, compact, robust, and calibrated tactile-sensing finger”. In: 2018 IEEE/RSJ International Conference on Intelligent Robots and Systems (IROS). IEEE. 2018, pp. 1927-1934.
[9] Mike Lambeta, Po-Wei Chou, Stephen Tian, et al. “Digit: A novel design for a low-cost compact high-resolution tactile sensor with application to in-hand manipulation”. In: IEEE Robotics and Automation Letters 5.3 (2020), pp. 3838-3845.
[10] Akhil Padmanabha, Frederik Ebert, Stephen Tian, et al. “Omnitact: A multi-directional high-resolution touch sensor”. In: 2020 IEEE International Conference on Robotics and Automation (ICRA). IEEE. 2020, pp. 618-624.
[11] Alex Alspach, Kunimatsu Hashimoto, Naveen Kuppuswamy, et al. “Soft-bubble: A highly compliant dense geometry tactile sensor for robot manipulation”. In: 2019 2nd IEEE International Conference on Soft Robotics (RoboSoft). IEEE. 2019, pp. 597-604.
[12] Jelizaveta Konstantinova, Agostino Stilli, and Kaspar Althoefer. Force and Proximity Fingertip Sensor to Enhance Grasping Perception. September 2015. DOI: 10. 1109/IROS.2015.7353659.
[13] Tess Hellebrekers, Kadri Bugra Ozutemiz, Jessica Yin, et al. “Liquid metal-microelectronics integration for a sensorized soft robot skin”. In: 2018 IEEE/RSJ International Conference on Intelligent Robots and Systems (IROS). IEEE. 2018, pp. 5924-5929.
[14] Jessica Yin, Tess Hellebrekers, and Carmel Majidi. “Closing the Loop with Liquid-Metal Sensing Skin for Autonomous Soft Robot Gripping”. In: 2020 3rd IEEE International Conference on Soft Robotics (RoboSoft). IEEE. 2020, pp. 661-667.
[15] Radhen Patel, Rebeca Curtis, Branden Romero, et al. “Improving Grasp Performance Using In-Hand Proximity and Contact Sensing”. In: Robotic Grasping and Manipulation. Ed. by Yu Sun and Joe Falco. Vol. 816. Series Title: Communications in Computer and Information Science. Cham: Springer International Publishing, 2018, pp. 146-160. DOI: 10. 1007/978-3-319-94568-2_9.
[16] Akihiko Yamaguchi and Christopher G Atkeson. “Combining finger vision and optical tactile sensing: Reducing and handling errors while cutting vegetables”. In: 2016 IEEE-RAS 16th International Conference on Humanoid Robots (Humanoids). IEEE. 2016, pp. 1045-1051.
[17] Francois R Hogan, Michael Jenkin, Sahand Rezaei-Shoshtari, et al. “Seeing Through your Skin: Recognizing Objects with a Novel Visuotactile Sensor”. In: Proceedings of the IEEE/CVF Winter Conference on Applications of Computer Vision. 2021, pp. 1218-1227.
[18] Tess Hellebrekers, Kevin Zhang, Manuela Veloso, et al. “Localization and Force-Feedback with Soft Magnetic Stickers for Precise Robot Manipulation”. In: 2020 IEEE/RSJ International Conference on Intelligent Robots and Systems (IROS). IEEE. 2020, pp. 8867-8874.
[19] Rui Rocha, Pedro Lopes, Anibal T de Almeida, et al. “Soft-matter sensor for proximity, tactile and pressure detection”. In: 2017 IEEE/RSJ International Conference on Intelligent Robots and Systems (IROS). IEEE. 2017, pp. 3734-3738.
[20] Gary Bradski and Adrian Kaehler. “OpenCV”. In: Dr. Dobb's journal of software tools 3 (2000).
[21] Huichan Zhao, Kevin O'Brien, Shuo Li, et al. “Optoelectronically innervated soft prosthetic hand via stretchable optical waveguides”. In: 0.
[22] Optimizing the Intel RealSense LiDAR Camera L515 Range. October 2020. URL: https://www.intelrealsense.com/optimizing-the-lidar-camera-1515-range/.

Aspects

The following Aspects are illustrative only and do not limit the scope of the present disclosure or the appended claims.
Aspect 1. A visuotactile sensor, comprising: a deformable membrane; and an imaging train, the deformable membrane allowing at least partial transmission of light therethrough and onto the imaging train such that the imaging train collects light reflected through the membrane by an object on the opposite side of the membrane or contacting the membrane, and the imaging train further configured to collect light indicative of a deformation of the membrane by the object.
Aspect 2. The visuotactile sensor of Aspect 1, wherein the deformable membrane comprises a pattern that distorts with deformation of the deformable membrane, and wherein the imaging train is configured to (i) illuminate the pattern so as to give rise to ultraviolet, infrared, or visible light emission or reflection from the pattern and (ii) collect an ultraviolet, infrared, or visible light image of the pattern.

A sensor can include, e.g., internal stereo RGB or infrared camera(s) with or without sources of light to sense membrane shape, tactile data, proximity data (e.g., a Leap Motion Sensor or Intel Realsense D405). An algorithm (e.g., with machine learning) can be developed with data from the sensor to identify, measure, and/or classify 6-axis forces/torques, textures, geometries, and simultaneous multiple contact patches of external target objects.

A membrane can be configured to have a variety of surface properties (e.g., different friction coefficients, microscale or macroscale features such as ridges or pillars) to suit a given application or use case. For example, a membrane can be molded to have fingerprint-like ridges that can be used to classify textures of objects to which the membrane is contacted.

A membrane's surface properties can be actively modulated with a range of vibration frequencies. A membrane can also be configured to include surface-mounted or embedded actuators that affect the membrane's shape, geometry, mechanical properties, optical properties, or the motion of an external object.

The actuators can also be used to extend the membrane's sensing capabilities. For example, by placing dielectric elastomers, voice coils, or arrays of actuators on the membrane, one can then locally vibrate the membrane. One can also sense vibrations at the resonant frequency of the membrane to localize contact on the membrane, e.g., using a machine learning model. A membrane's pattern can be activated and be sensed by ultraviolet, infrared, or visible light, or any combination of those.

The sensor can include one or a plurality of membranes and/or multiple internal cameras, to extend the field of view or sensing area. A sensor can include one or more internal mirrors to change the pathways of infrared, ultraviolet, and/or visible light, and thereby change the geometry/shape/location/position of the membrane and/or sensor.

A membrane can be transparent, phosphorescent, fluorescent, or reflective of infrared, visible, and/or ultraviolet light without the addition of a dye. A membrane can include regions of different properties, e.g., a region that is transparent to ultraviolet light and a region that is opaque to ultraviolet light.

The membrane can be mechanically inextensible, such as being made of a thin or flexible plastic material. A membrane can also be stretchable (e.g., elastomeric) in nature.
Aspect 3. The visuotactile sensor of Aspect 2, wherein the pattern comprises a pigment, the pigment optionally absorbing ultraviolet light and emitting visible light.
Aspect 4. The visuotactile sensor of any one of Aspects 1-3, wherein (a) the light reflected by an object on the opposite side of the membrane or contacting the membrane is infrared light, (b) wherein the light indicative of a deformation of the membrane by the object is visible light, or both (a) and (b).
Aspect 5. The visuotactile sensor of any one of Aspects 1-4, wherein the deformable membrane is substantially transparent to infrared light and is substantially opaque to visible light having a wavelength of from about 400 to about 700 nm
Aspect 6. The visuotactile sensor of any one of Aspects 1-5, wherein the imaging train comprises any one or more of a an ultraviolet light camera, a visual light camera, an infrared light camera, a source of ultraviolet light, a source of visible light, and a source of infrared light. It should be understood, however, that the imaging train need not include a source of illumination.
Aspect 7. The visuotactile sensor of any one of Aspects 1-6, further comprising an enclosure, the membrane forming a boundary of the enclosure. It should be understood, however, that the sensor need not include an enclosure, i.e., the membrane can be exposed to “open air” and need not bound an enclosure; in particular, the membrane need not bound a pressurized enclosure. A sensor can operate based on membrane deflection in “open air”, i.e., membrane deflection that is not resisted by a pressure within an enclosure that is at least partially bounded by the membrane.
Aspect 8. The visuotactile sensor of Aspect 7, further comprising a source of pressure configured to exert a pressure within the enclosure.
Aspect 9. The visuotactile sensor of any one of Aspects 7-8, further comprising a pressure sensor configured to measure a pressure within the enclosure.

The sensor's enclosure can be filled with air, but this is not a requirement. The enclosure can be filled with a fluid other than air (e.g., a liquid) in a chamber of the enclosure (which can comprise one or more chambers), and the fluid can be used to detect pressure or other types of data. Filling the sensor's enclosure with an incompressible fluid can cause a different type of deformation and interaction with the target object. Additionally, measuring the change of a fluid flowing out of one chamber of the sensor (e.g., from one chamber into another) can be used to measure contact or displaced volume within the chamber.

The sensor can also be filled with transparent foam, discrete springs, different elastomers, and different hydrogels, or any combination of those, to provide mechanical resistance without relying on an internal fluid or pressure source.
Aspect 10. The visuotactile sensor of any one of Aspects 1-9, further comprising a processor configured to (a) relate a pressure within the enclosure to a deformation of the membrane, (b) modulate a pressure exerted against the deformable membrane, (c) relate an image of a pattern of the membrane to one or more pattern reference images, (d) relate an image of a pattern of the membrane to a deformation of the membrane, (e) relate a deformation of the membrane to a force exerted by the object on the membrane, (f) relate a deformation of the membrane to a torque exerted by the object on the membrane, (g) relate a deformation of the membrane to a position of the object on the membrane, or (h) any two or more of (a)-(g). Thus, the processor can be configured to perform any one or more of (a)-(g).
Aspect 11. The visuotactile sensor of any one of Aspects 1-10, wherein the imaging train is configured to relate at least one of (i) light reflected through the membrane by the object on the opposite side of the membrane or contacting the membrane and (ii) light indicative of a deformation of the membrane by the object to at least one of a torque exerted on the membrane by the object, a force exerted on the membrane by the object, an optical characteristic of the object, a geometric characteristic of the object, a material characteristic of the object, a mechanical characteristic of the object, a position of the object, or any combination thereof. Accordingly, the disclosed sensors can be used to sense any one or more of position, force, and torque (which sensing can be at the same time) of an object that is contact with the membrane.
Aspect 12. The visuotactile sensor of any one of Aspects 1-11, further comprising a mechanism, the mechanism configured to move the deformable membrane.
Aspect 13. The visuotactile sensor of any one of Aspects 1-12, wherein the visuotactile sensor is incorporated into a furnishing, a bed, a vehicle, an assembly system, a positioning system, a gripper, a robot, a prosthetic, a wearable device, a computer input device, a shelf, or any combination thereof.

As but one illustrative example of the disclosed technology, a robotic gripper and/or fingers can be mounted above, to, or below the membrane of a sensor according to the present disclosure. A sensor can be mounted to, distributed across, or attached to a humanoid robot body, AR/VR/video game controller (e.g., grip or handle), or a human body (e.g., wearable device, prosthetics at the interface with the body to check for a good fit and monitor stresses at the interface). A sensor can be used as a 6-DoF input device to a computer user interface (e.g., similar to a mouse input).

Because the disclosed sensors can collect various forms of useful information, they can be used in a broad number of applications. A sensor according to the present disclosure can be scaled up or down in size, for integration with a robotic fingertip to integration with a robotic bed.

As one example, a sensor according to the present disclosure can be used for perception of objects within cluttered and confined spaces (e.g., refrigerator shelves, warehouse shelves, kitchen shelves, bookshelves, dishwasher). A sensor according to the present disclosure can also be used as part of a heterogeneous system with many other different sensors or cameras. For example, a sensor can be an entire shelf and be configured to sense objects (e.g. sensing the weight of an object placed on it, sensing the approach of an object, sensing the removal of an object, sensing the position of an object).

A sensor can be used to apply and predict the spin and trajectory of target objects thrown from the sensor. This can be useful in, e.g., applications where it is useful or even necessary to monitor the movement of flying objects.

A sensor with and without embedded or surface-mounted actuators can be used to build a geometric, dynamic, quasi-static, and material model of a manipulated object. A sensor according to the present disclosure can be used provide data input to an algorithm that is used to determine a functional or optimal trajectory, motion, or action of a robotic body/arm/furnishing/vehicle etc.

Relatedly, a sensor can be used to detect, measure, and identify contact patches with high deformations of the sensing surface or of deformable target objects. A sensor can also be used to develop and study lower dimensional representations of target objects.

The sensor can be used for pushing large and/or heavy objects, relative to the mechanical properties or size of the membrane. A membrane with embedded or surface mounted actuators can also be used in this approach. Similarly, an actuated membrane with embedded, surface-mounted, or externally mounted actuators (pulling, rolling) can be used for fine positioning of an object on the surface.

The sensor can be used to sense a person's pose, pressure points for body-sized surfaces, and track how long (time) they have been on the surface (for health monitoring). This can be especially useful in inpatient settings, where monitoring of a patient's position can be used to advise caregivers of the need to move the patient so as to prevent the formation of pressure sores or other injuries.

When a sensor includes an internal light source (which is not a requirement), the internal light source(s) (IR, UV, visible) from the sensor can change the optical (e.g., color), mechanical, dynamic, or geometric properties of an external object without making contact with the object. A sensor can be used to predict touch or interaction before contact occurs, for example being integrated into or comprising of an active haptic interface (e.g., an interfaces that changes its shape or geometry to reach out to or avoid the touch).

The tactile sensing capabilities of the sensor can be used to sense non-reflective or occluded areas from the proximity sensing. The sensor (e.g., via selection of membrane material) can emulate or have similar mechanical properties that of animal, plant, or human skin/flesh for further applications. For example, one can utilize a flesh-similar membrane or pseudo-flesh in medical education or testing dummies.

A sensor can be used in an instrumented system used to measure and characterize modalities of haptic actuators (skin stretch, shear/normal force, compression, etc.). Likewise, a sensor (and data collected by the sensor) can be used as an input to a computer user interface; e.g., a mouse pad with force input (multi finger gestures, non-contact gestures).
Aspect 14. A system, comprising: a visuotactile sensor that comprises a deformable membrane and an imaging train, the imaging train configured to collect (i) light reflected through the deformable membrane by an object proximate to or contacting the membrane and (ii) light indicative of a deformation of the deformable membrane; and a mechanism, the system configured to actuate the mechanism in response to a light collected by the imaging train, the light being indicative of any one or more of a position of the object, a motion of the object, and a deformation experienced by the membrane.
Aspect 15. The system of Aspect 14, wherein the mechanism effects relative motion between the visuotactile sensor and the object in response to a deformation of the membrane that exceeds a threshold magnitude and/or a threshold duration.
Aspect 16. The system of any one of Aspects 14-15, wherein the mechanism is configured to move the object.
Aspect 17. The system of any one or Aspects 14-16, wherein the mechanism is configured to effect motivation or activation of an element exterior to the sensor.
Aspect 18. The system of any one of Aspects 14-17, wherein the system is comprised in a furnishing, a bed, a vehicle, an assembly system, a positioning system, or any combination thereof.
Aspect 19. A method, comprising: with an imaging train, collecting (a) a first light reflected through a deformable membrane by an object proximate to or contacting the deformable membrane and (b) a second light indicative of a deformation of the deformable membrane; and relating the at least one of the first light and the second light to an estimated position of the object, an estimated motion of the object, and an estimated deformation experienced by the membrane.
Aspect 20. The method of Aspect 19, further comprising adjusting a position or motion of the object or of the deformable membrane in response to at least one of the position of the object, the motion of the object, or the deformation experienced by the membrane.
Aspect 21. The method of any one of Aspects 19-20, further comprising generating a model of a trajectory of the object.
Aspect 22. The method of any one of Aspects 19-21, further comprising actuating a mechanism in response to any one or more of the estimated position of the object, the estimated motion of the object, and the estimated deformation experienced by the membrane.
Aspect 23. The method of any one of Aspects 19-22, wherein the mechanism is comprised in a furnishing, a bed, a vehicle, an assembly system, a positioning system, or any combination thereof.

What is claimed:

1. A visuotactile sensor, comprising:
a deformable membrane; and
an imaging train,
the deformable membrane allowing at least partial transmission of light therethrough and onto the imaging train such that the imaging train collects light reflected through the membrane by an object on the opposite side of the membrane or contacting the membrane, and
the imaging train further configured to collect light indicative of a deformation of the membrane by the object.

2. The visuotactile sensor of claim 1, wherein the deformable membrane comprises a pattern that distorts with deformation of the deformable membrane, and wherein the imaging train is configured to (i) illuminate the pattern so as to give rise to ultraviolet, infrared, or visible light emission or reflection from the pattern and (ii) collect an ultraviolet, infrared, or visible light image of the pattern.

3. The visuotactile sensor of claim 2, wherein the pattern comprises a pigment, the pigment optionally absorbing ultraviolet light and emitting visible light.

4. The visuotactile sensor of claim 1, wherein (a) the light reflected by an object on the opposite side of the membrane or contacting the membrane is infrared light, (b) wherein the light indicative of a deformation of the membrane by the object is visible light, or both (a) and (b).

5. The visuotactile sensor of claim 1, wherein the deformable membrane is substantially transparent to infrared light and is substantially opaque to visible light having a wavelength of from about 400 to about 700 nm.

6. The visuotactile sensor of claim 1, wherein the imaging train comprises any one or more of a an ultraviolet light camera, a visual light camera, an infrared light camera, a source of ultraviolet light, a source of visible light, and a source of infrared light.

7. The visuotactile sensor of claim 1, further comprising an enclosure, the membrane forming a boundary of the enclosure.

8. The visuotactile sensor of claim 7, further comprising a source of pressure configured to exert a pressure within the enclosure.

9. The visuotactile sensor of claim 7, further comprising a pressure sensor configured to measure a pressure within the enclosure.

10. The visuotactile sensor of claim 1, further comprising a processor configured to (a) relate a pressure within an enclosure of the sensor to a deformation of the membrane, (b) modulate a pressure exerted against the deformable membrane, (c) relate an image of a pattern of the membrane to one or more pattern reference images, (d) relate an image of a pattern of the membrane to a deformation of the membrane, (e) relate a deformation of the membrane to a force exerted by the object on the membrane, (f) relate a deformation of the membrane to a torque exerted by the object on the membrane, (g) relate a deformation of the membrane to a position of the object on the membrane, or (h) any two or more of (a)-(g).

11. The visuotactile sensor of claim 1, wherein the imaging train is configured to relate at least one of (i) light reflected through the membrane by the object on the opposite side of the membrane or contacting the membrane and (ii) light indicative of a deformation of the membrane by the object to at least one of a torque exerted on the membrane by the object, a force exerted on the membrane by the object, an optical characteristic of the object, a geometric characteristic of the object, a material characteristic of the object, a mechanical characteristic of the object, a position of the object, or any combination thereof.

12. The visuotactile sensor of claim 1, further comprising a mechanism, the mechanism configured to move the deformable membrane.

13. The visuotactile sensor of claim 1, wherein the visuotactile sensor is incorporated into a furnishing, a bed, a vehicle, an assembly system, a positioning system, a gripper, a robot, a prosthetic, a wearable device, a computer input device, a shelf, or any combination thereof.

14. A system, comprising:
a visuotactile sensor that comprises a deformable membrane and an imaging train,
the imaging train configured to collect (i) light reflected through the deformable membrane by an object proximate to or contacting the membrane and (ii) light indicative of a deformation of the deformable membrane; and
a mechanism,
the system configured to actuate the mechanism in response to a light collected by the imaging train,
the light being indicative of any one or more of a position of the object, a motion of the object, and a deformation experienced by the membrane.

15. The system of claim 14, wherein the mechanism effects relative motion between the visuotactile sensor and the object in response to a deformation of the membrane that exceeds a threshold magnitude and/or a threshold duration.

16. The system of any claim 14, wherein the mechanism is configured to move the object.

17. The system of claim 14, wherein the mechanism is configured to effect motivation or activation of an element exterior to the sensor.

18. The system of claim 14, wherein the system is comprised in a furnishing, a bed, a vehicle, an assembly system, a positioning system, or any combination thereof.

19. A method, comprising:
with an imaging train, collecting (a) a first light reflected through a deformable membrane by an object proximate to or contacting the deformable membrane and (b) a second light indicative of a deformation of the deformable membrane; and
relating the at least one of the first light and the second light to an estimated position of the object, an estimated motion of the object, and an estimated deformation experienced by the membrane.

20. The method of claim 19, further comprising adjusting a position or motion of the object or of the deformable membrane in response to at least one of the position of the object, the motion of the object, or the deformation experienced by the membrane.

21. The method of claim 19, further comprising generating a model of a trajectory of the object.

22. The method of claim 19, further comprising actuating a mechanism in response to any one or more of the estimated position of the object, the estimated motion of the object, and the estimated deformation experienced by the membrane.

23. The method of claim 19, wherein the mechanism is comprised in a furnishing, a bed, a vehicle, an assembly system, a positioning system, or any combination thereof.
